(19) United States
(12) Patent Application Publication
(10) Pub. No.: US 2025/0132308 A1
(43) Pub. Date: Apr. 24, 2025

(54) NEGATIVE ELECTRODE AND METHOD OF PRODUCING THE SAME, AND NON-AQUEOUS ELECTROLYTE SECONDARY BATTERY INCLUDING NEGATIVE ELECTRODE AND METHOD OF PRODUCING THE SAME

(71) Applicant: Prime Planet Energy & Solutions, Inc., Tokyo (JP)

(72) Inventor: Hajime TAMURA, Kobe-shi (JP)

(21) Appl. No.: 18/889,300

(22) Filed: Sep. 18, 2024

(30) Foreign Application Priority Data
Oct. 24, 2023 (JP) 2023-182473

(51) Int. Cl. H01M 4/133; H01M 4/02; H01M 4/1393; H01M 4/587; H01M 4/62

(52) U.S. Cl. CPC H01M 4/133; H01M 4/1393; H01M 4/587; H01M 4/622; H01M 4/625; H01M 2004/027

(57) ABSTRACT

A negative electrode has an active material layer including active material particles, carbon nanotubes (CNTs), and a first binder. The active material particles include metal-based active material particles and carbon-based active material particles. An average length of the CNTs determined by analysis of a scanning transmission electron microscope image of the active material layer is 1.5 μm or more. At least part of the first binder is not mixed with the CNTs and covers at least part of a surface of the active material particle. The CNTs include first CNTs adhered to and lying over the first binder, and second CNTs each connecting a pair of the active material particles to each other.

### CROSS REFERENCE TO RELATED APPLICATIONS

This nonprovisional application is based on Japanese Patent Application No. 2023-182473 filed on Oct. 24, 2023, with the Japan Patent Office, the entire contents of which are hereby incorporated by reference.

### BACKGROUND OF THE INVENTION

### Field of the Invention

The present invention relates to a negative electrode and a method of producing the same, and a non-aqueous electrolyte secondary battery including a negative electrode and a method of producing the same.

### Description of the Background Art

A non-aqueous electrolyte secondary battery has a negative electrode that includes an active material layer. The active material layer may include active material particles such as graphite and SiOx, as well as fibrous carbon such as carbon nanotubes (see Japanese Patent Laying-Open No. 2021-99955, for example).

### SUMMARY OF THE INVENTION

Metal-based active material particles such as SiOx are less electrically conductive than graphite and undergo a great extent of expansion and shrinkage during charge and discharge of the secondary battery, so a conductive path formed between the metal-based active material particle and a neighboring active material particle can be easily deteriorated, likely to cause degradation of cycling performance of the secondary battery. Carbon nanotubes connect active material particles to each other and thereby can form good conductive paths, so they are used for reducing the above-mentioned deterioration of conductive paths. However, even when the active material layer includes carbon nanotubes, cycling performance of the secondary battery can sometimes degrade.

An object of the present disclosure is to provide a negative electrode that makes it possible to produce a secondary battery with excellent cycling performance and a method of producing the same, and a non-aqueous electrolyte secondary battery including a negative electrode and a method of producing the same.

[1] A negative electrode for a non-aqueous electrolyte secondary battery, comprising:
an active material layer including active material particles, carbon nanotubes, and a first binder, wherein
the active material particles include metal-based active material particles and carbon-based active material particles,
an average length of the carbon nanotubes determined by analysis of a scanning transmission electron microscope image of the active material layer is 1.5 μm or more,
at least part of the first binder is not mixed with the carbon nanotubes and covers at least part of a surface of the active material particle, and
the carbon nanotubes include first carbon nanotubes adhered to and lying over the first binder that is not mixed with the carbon nanotubes and covers a surface of the active material particle, and second carbon nanotubes each connecting a pair of the active material particles to each other.

[2] The negative electrode according to [1], wherein a proportion of the carbon nanotubes that are not mixed with the first binder to all the carbon nanotubes present in the active material layer determined by analysis of the scanning transmission electron microscope image of the active material layer is more than 60%.

[3] The negative electrode according to [1] or [2], wherein the metal-based active material particles include particles of one or more types selected from the group consisting of Si, SiOx, and a Si—C composite.

[4] The negative electrode according to any one of [1] to [3], wherein the metal-based active material particles include particles of a Si—C composite.

[5] The negative electrode according to any one of [1] to [4], wherein the carbon nanotubes are single-walled carbon nanotubes.

[6] The negative electrode according to any one of [1] to [5], wherein a G/D ratio of the carbon nanotubes is 80 or less.

[7] The negative electrode according to any one of [1] to [6], wherein the first binder is at least one of carboxymethylcellulose and polyacrylic acid.

[8] The negative electrode according to [7], wherein
the active material layer includes a second binder, the second binder is different from the first binder, and
the second binder includes styrene-butadiene rubber.

[9] A non-aqueous electrolyte secondary battery comprising the negative electrode according to any one of [1] to [8].

[10] A method of producing a negative electrode for a non-aqueous electrolyte secondary battery, the method comprising:
a first step to prepare a slurry; and
a second step to form an active material layer of the negative electrode by using the slurry, wherein
the slurry includes active material particles, a first binder, carbon nanotubes, and water,
the active material particles include metal-based active material particles and carbon-based active material particles, and
the first step includes
   a step (1a) to obtain a first mixed-kneaded body by mixing and kneading the active material particles, the first binder, and water at a solid content within a range of 60 to 65 weight %,
   a step (1b) to obtain a second mixed-kneaded body by adding water to the first mixed-kneaded body and mixing and kneading at a solid content within the range of 50 weight % or less, and
   a step (1c) to obtain a third mixed-kneaded body by mixing and kneading the second mixed-kneaded body and the carbon nanotubes.

[11] The method of producing a negative electrode according to [10], wherein
the first binder is at least one of carboxymethylcellulose and polyacrylic acid,
the first step further includes a step to mix and knead the third mixed-kneaded body and a second binder, and
the second binder includes styrene-butadiene rubber.

[12] The method of producing a negative electrode according to or [11], wherein the step (1a) includes:
a step to dry mix the active material particles and the first binder to obtain a mixture; and
a step to mix and knead the mixture and water at a solid content within a range of 60 to 65 weight %.

[13] The method of producing a negative electrode according to any one of to [12], wherein the metal-based active material particles include particles of one or more types selected from the group consisting of Si, SiOx, and a Si—C composite.

[14] The method of producing a negative electrode according to any one of to [13], wherein the first binder is at least one of carboxymethylcellulose and polyacrylic acid.

[15] The method of producing a negative electrode according to any one of to [14], wherein a G/D ratio of the carbon nanotubes is 80 or less.

[16] A method of producing a non-aqueous electrolyte secondary battery, the method comprising a step to produce a negative electrode by the method of producing a negative electrode according to any one of to [15].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a descriptive view schematically illustrating an example of the state inside an active material layer of a negative electrode according to an embodiment.

FIG. 2 is a descriptive view schematically illustrating an example of the state inside an active material layer of a negative electrode produced by the procedure described in Comparative Examples.

FIG. 3 is a flowchart illustrating a method of producing a negative electrode according to an embodiment.

FIG. 4 is a scanning transmission electron microscope image of a surface of an active material layer of a negative electrode obtained in Example 1.

FIG. 5 is a scanning transmission electron microscope image of a surface of an active material layer of a negative electrode obtained in Example 2.

FIG. 6 is a scanning transmission electron microscope image of a surface of an active material layer of a negative electrode obtained in Comparative Example 1.

FIG. 7 is a scanning transmission electron microscope image of a surface of an active material layer of a negative electrode obtained in Comparative Example 2.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Negative Electrode)

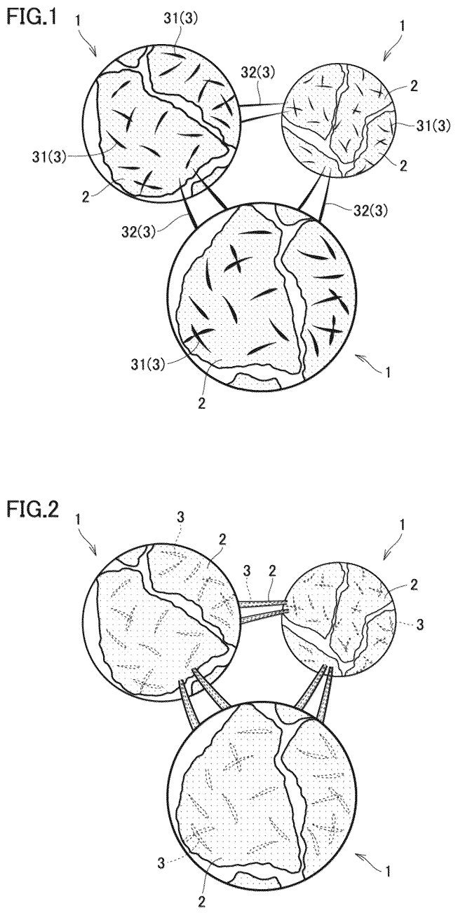

FIG. 1 is a descriptive view schematically illustrating an example of the state inside an active material layer of a negative electrode according to an embodiment. FIG. 2 is a descriptive view schematically illustrating an example of the state inside an active material layer of a negative electrode produced by the procedure described in Comparative Examples.

A negative electrode according to the present embodiment (hereinafter also called “the present negative electrode”) is a negative electrode for a non-aqueous electrolyte secondary battery (hereinafter also called “a secondary battery”), and includes an active material layer. The active material layer includes active material particles, carbon nanotubes (hereinafter also called “CNTs”), and a first binder. The active material particles include metal-based active material particles (hereinafter also called “metal-based particles”) and carbon-based active material particles (hereinafter also called “carbon-based particles”). The average length of the CNTs determined by analysis of a scanning transmission electron microscope image (hereinafter also called “an SEM image”) of the active material layer is 1.5 μm or more. At least part of the first binder is not mixed with the CNTs and covers at least part of a surface of the active material particle. The CNTs include first carbon nanotubes (hereinafter also called “first CNTs”) that are adhered to the first binder that is not mixed with the CNTs and covers a surface of the active material particle, in such a manner to lie over the surface of the first binder, as well as second carbon nanotubes (hereinafter also called “second CNTs”) each connecting a pair of the active material particles to each other.

The present negative electrode may have the active material layer on its negative electrode current collector. The active material layer may be formed on only one side of the negative electrode current collector, or may be formed on both sides thereof. The negative electrode current collector is a metal foil that is made by using a copper material such as copper and copper alloy, for example.

The active material layer includes an active material particle 1 at least part of the surface of which is covered with a first binder 2 (FIG. 1). To the surface of active material particle 1, first binder 2 can be directly adhered. It is simply required that at least part of the entire surface of active material particle 1 is covered with first binder 2. For example, first binder 2 may be scattered throughout the entire surface of active material particle 1, or first binder 2 may be present all over the entire surface of active material particle 1.

First binder 2 covering active material particle 1 includes a first binder that is at least not mixed with CNTs 3 (hereinafter also called “the first binder(s)”), and may also include a first binder that is mixed with CNTs 3 (hereinafter also called “the first binder (m)”). When first binder 2 includes the first binder (m), the area occupied by the first binder(s) in an SEM image of the surface of the active material layer is preferably greater than the area occupied by the first binder (m). In the present specification, in an SEM image of the surface of the active material layer, all CNTs present on the surface of the first binder or inside thereof are identified, and then the total area of CNTs not covered with the first binder (the former) and the total area of CNTs covered with the first binder (the latter) are calculated; a first binder present in a region where the proportion of the former to the sum of the former and the latter is 80% or more is defined as the first binder(s), and a first binder present in a region where the above-mentioned proportion is less than 20% is defined as the first binder (m).

In the active material layer, a first CNT 31 is adhered to the first binder(s) covering active material particle 1, in such a manner to lie over the surface of the first binder(s) (FIG. 1). First CNT 31 across its entire length may be adhered to the first binder(s), or only a part of its length may be adhered to the first binder(s). Herein, first CNT 31 refers to a CNT at least 80% of the entire length of which is present on the surface of the first binder(s) and which is not a second CNT 32. When the proportion of first CNTs 31 to all the CNTs in the active material layer is high, it is indicated that, at the time of preparation of a slurry for forming the active material layer, the slurry was prepared under conditions where the first binder and the CNTs tend not to be mixed together. As explained below in the description of a production method, for example, such conditions include a relatively low solid concentration at the time of mixing the first binder and the CNTs.

In the active material layer, second CNT 32 connects a pair of active material particles 1 to each other (FIG. 1). Both ends of second CNT 32 can be in direct contact with the surface of the pair of active material particles 1 or with the surface of first binder 2 covering active material particle 1. With the average length of the CNTs included in the active material layer being 1.5 μm or more, second CNT 32 tends to form a good conductive path between active material particles 1. Thereby, a secondary battery including the present negative electrode can have excellent cycling performance.

An active material layer that includes the first CNTs and the second CNTs may be obtained by adjusting, for example, conditions during preparation of a slurry that is to be used for forming the active material layer (to be described below), such as the timing to mix CNTs as well as the solid concentration at the time of mixing CNTs. As explained below in Examples, for example, an active material layer including the first CNTs and the second CNTs can be obtained by using a slurry prepared by mixing and kneading a mixed-kneaded body including the active material particles and the first binder and having a relatively low solid content, with CNTs.

On the other hand, as explained below in Comparative Examples, for example, when an active material layer is obtained by using a slurry prepared by mixing and kneading the active material particles, the first binder, and CNTs at a relatively high solid content, an active material layer including the first CNTs and the second CNTs tends not to be obtained. In this case, as see in FIG. 2, an active material layer in which a mixed body in which CNTs 3 and first binder 2 are mixed covers the surface of active material particle 1 and connects a pair of active material particles 1 to each other tends to be obtained. In the active material layer illustrated in FIG. 2, the proportion of the surface of first binders 2 with exposed CNT surfaces is relatively low and the proportion of the surface of CNTs 3 covered with first binders 2 is relatively high.

The CNTs included in the active material layer may include third carbon nanotubes (third CNTs) each of which is adhered to, and lies over the surface of, a first binder (m) covering an active material particle.

The proportion of CNTs not mixed with the first binder to all the CNTs in the active material layer (hereinafter also called “the CNT proportion”) is preferably more than 60%, more preferably 70% or more, further preferably 80% or more, and it may be 85% or more. Preferably, the CNT proportion is more than 60% and not more than 100%, and it may be from 70 to 99%, or may be from 80 to 95%. When the CNT proportion falls within the above-mentioned range, good conductive paths can be formed between the active material particles, and thereby cycling performance of the secondary battery can be enhanced. The CNT proportion can be determined by analysis of an SEM image of the active material layer, as described below in Examples.

The proportion of the CNTs may be adjusted to the above-mentioned proportion by adjusting, for example, conditions during preparation of a slurry that is to be used for forming the active material layer, such as the solid concentration at the time of mixing the CNTs.

The active material layer includes negative-electrode active material particles. The active material particles include metal-based particles and carbon-based particles, and may include active material particles other than metal-based particles and carbon-based particles. The total content of the carbon-based particles and the metal-based particles included in the active material particles may be from 90 to 100 weight %, or may be from 90 to 99 weight %, or may be from 92 to 95 weight % of all the active material particles. As for the ratio between the carbon-based particles and the metal-based particles in the active material particles, the weight ratio of (carbon-based particles):(metal-based particles) may be from 70:30 to 95:5, or may be from 80:20 to 92:8, or may be from 85:15 to 95:5.

When the active material layer is formed on both sides of the negative electrode current collector, the mass of the active material layer per unit area for both sides (the sum of both sides) may be from 150 to 250 g/m², or may be from 170 to 230 g/m², or may be from 180 to 210 g/m², for example. The mass per unit area of the negative electrode current collector per one side can be regarded as half the above-mentioned mass per unit area for both sides, for example. The thickness of the active material layer per one side may be from 90 to 200 μm, or may be from 100 to 180 μm, or may be from 120 to 150 μm, for example. The packing density of the active material layer can be calculated by the following equation, and may be from 1.3 to 1.9 g/cc, or may be from 1.4 to 1.8 g/cc, or may be from 1.5 to 1.7 g/cc, for example.

Packing density [g/cc]=(Mass of active material layer per unit area [g/m²])/(Thickness of active material layer [μm])

The metal-based particles include particles of a metallic element such as an elemental metal or a metal oxide including an element selected from the group consisting of silicon (Si), tin (Sn), antimony (Sb), bismuth (Bi), titanium (Ti), and germanium (Ge). Preferably, the metal-based particles include particles of one or more types selected from the group consisting of Si, SiOx (x=0.5 to 1.5), a Si—C composite (hereinafter also called “a SiC composite”), and Sn, or they are particles of one or more types selected from this group; more preferably, they are particles of one or more types selected from the group consisting of Si, SiOx, and a SiC composite. Further preferably, the metal-based particles are SiC composite particles. The SiC composite is, for example, a composite in which Si is dispersed in the carbon matrix.

Preferably, the carbon-based particles include particles of one or more types selected from the group consisting of carbon materials such as graphite, hard carbon, soft carbon, and amorphous-coated graphite, or they are particles of one or more types selected from this group; preferably, they include graphite particles, or they are graphite particles. The average particle size, D50, of the graphite particles may be from 5 to 25 μm, or may be from 8 to 23 μm, or may be from 10 to 20 μm. The average particle size D50 herein refers to the particle size in volume-based particle size distribution at which cumulative frequency of particle sizes accumulated from the small size side reaches 50%. The volume-based particle size distribution can be measured with a laser-diffraction particle size distribution analyzer. The specific surface area (BET) of the graphite particles may be from 1.0 m²/g to 3.0 m²/g, or may be from 1.2 m²/g to 2.5 m²/g. The specific surface area can be calculated by a BET multi-point method in an absorption isotherm obtained by measurement by a gas adsorption method with the use of a fully-automatic specific surface area meter and/or the like.

The CNTs may be single-walled carbon nanotubes (hereinafter also called “SWCNTs”), or may be multi-walled carbon nanotubes such as double-walled carbon nanotubes (DWCNTs). From the viewpoint of obtaining CNTs with less defects in the CNT structure and with greater G/D ratio, the CNTs are preferably SWCNTs.

The average length of the CNTs in the active material layer is 1.5 μm or more, or may be 1.6 μm or more, or may be 1.7 μm or more, or may be 1.8 μm or more, or may be 1.9 μm or more, or may be 2.0 μm or more. The average length of the CNTs may be from 1.5 to 5.0 μm, or may be from 1.8 to 3.0 μm, or may be from 2.0 to 2.5 μm. The average length of the CNTs can be determined by analysis of an SEM image as described below in Examples. It is conceivable that when CNTs with the above-mentioned average length are present in the active material layer, good conductive paths can be formed between the active material particles and cycling performance of the secondary battery can be enhanced.

The G/D ratio of the CNTs may be 80 or less, or may be 70 or less, or may be 50 or less, and it is preferably 30 or less, or may be 20 or less. The G/D ratio of the CNTs may be from 5 to 80, or may be from 10 to 50, or may be from 10 to 30. The G/D ratio is a value determined by Raman spectrometry. In the Raman spectrum of the CNTs, the Raman shift at or near 1590 cm⁻¹ is called a G band which is attributable to graphite, and the Raman shift at or near 1350 cm⁻¹ is called a D band which is attributable to amorphous carbon and/or defects of graphite. Hence, it can be said that the greater the G/D ratio, the higher the crystallinity and strength of the CNTs. When a slurry that includes CNTs, active material particles, and a first binder is used as described below for forming the active material layer, and a strong shearing force is applied to these components while they are mixed and kneaded, for the purpose of enhancing dispersibility of the CNTs, the CNTs can be sometimes cut into short pieces or otherwise become shorter. On the other hand, in the present embodiment, because the timing to add CNTs during slurry preparation is adjusted as described below, even when CNTs with a low G/D ratio (less strong) are used, it is possible to prevent the CNTs from becoming shorter. This enables formation of good conductive paths between the active material particles, enhancing cycling performance of the secondary battery. The G/D ratio herein is a value calculated by defining G as the intensity of the highest peak appearing within the range of 1550 to 1650 cm⁻¹ in the Raman spectrum of the CNTs and defining D as the intensity of the highest peak appearing within the range of 1300 to 1400 cm⁻¹. The G/D ratio of the CNTs can be determined by the procedure described below in Examples.

The content of the CNTs in the active material layer may be from 0.01 to 1 part by weight, or may be from 0.05 to 0.1 parts by weight, or may be from 0.1 to 0.5 parts by weight, relative to 100 parts by weight of the active material particles.

The first binder may be one or more types selected from the group consisting of cellulose-based binders such as carboxymethylcellulose (hereinafter also called “CMC”), methylcellulose (hereinafter also called “MC”), and hydroxypropylcellulose and polyacrylic acid (hereinafter also called “PAA”). Preferably, the first binder includes at least one of CMC and PAA, more preferably includes CMC and PAA. Each of CMC, MC, and PAA may be either in acid form or in salt form, preferably in salt form. Examples of the salt include salts of an alkali metal such as potassium and sodium.

The content of the first binder in the active material layer may be from 0.5 to 5 parts by weight, or may be from 1 to 4 parts by weight, or may be from 2 to 3 parts by weight, relative to 100 parts by weight of the active material particles. When two or more first binders are used, the content of the first binder refers to the total amount of them.

In addition to the active material particles, the CNTs, and the first binder, the active material layer may include a second binder which is not the first binder, a conductive material other than CNTs, and/or the like. When the first binder includes at least one of CMC and PAA, or when it is at least one of CMC and PAA, the second binder may include at least one of styrene-butadiene rubber (SBR) and polyvinyl alcohol (PVA), and, preferably, it includes SBR. Examples of the conductive material other than CNTs include carbon materials such as carbon black (for example, acetylene black, Ketjenblack), coke, activated carbon, and the like.

### (Method of Producing Negative Electrode)

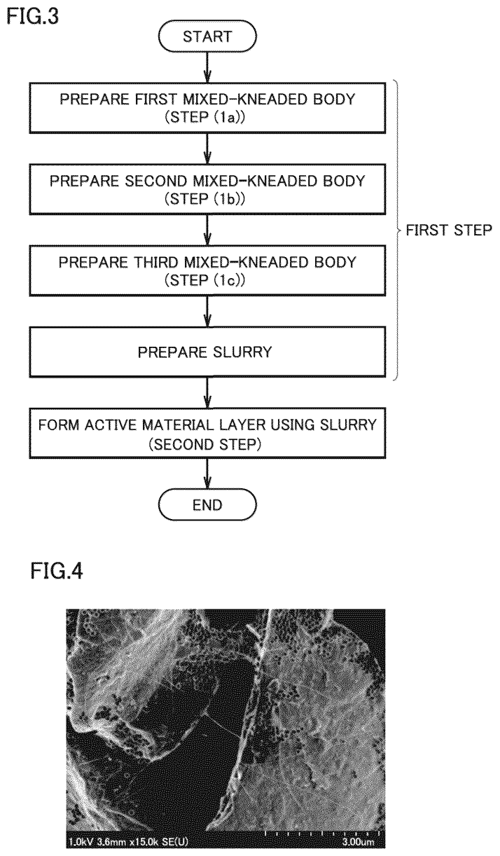

FIG. 3 is a flowchart illustrating a method of producing a negative electrode according to an embodiment. The method of producing a negative electrode according to the present embodiment is capable of producing a negative electrode for a secondary battery, and it is also capable of producing the present negative electrode. The method of producing a negative electrode includes a first step to prepare a slurry, and a second step to form an active material layer of the negative electrode by using the slurry (FIG. 3). The slurry includes active material particles, a first binder, CNTs, and water. The active material particles include metal-based particles and carbon-based particles.

As each of the metal-based particles and the carbon-based particles, the above-mentioned material may be used. As the first binder, the above-mentioned material may be used. As the CNTs, the above-mentioned material may be used, preferably SWCNTs. The G/D ratio of the CNTs may be set to fall within the above-mentioned range.

The slurry may further include a second binder, and may include a conductive material other than CNTs. As each of the second binder and the conductive material, the above-mentioned material may be used.

The solid content of the slurry prepared in the first step may be from 35 to 55 weight %, or may be from 40 to 50 weight %, or may be from 43 to 48 weight %.

The first step includes:
a step (1a) to obtain a first mixed-kneaded body by mixing and kneading active material particles, a first binder, and water at a solid content within the range of 60 to 65 weight %;
a step (1b) to obtain a second mixed-kneaded body by adding water to the first mixed-kneaded body and mixing and kneading at a solid content within the range of 50 weight % or less; and
a step (1c) to obtain a third mixed-kneaded body by mixing and kneading the second mixed-kneaded body and CNTs (FIG. 3).

In the method of producing a negative electrode, active material particles and a first binder are mixed and kneaded at a relatively high solid content to obtain a first mixed-kneaded body (the step (1a)), and the first mixed-kneaded body is diluted to obtain a second mixed-kneaded body (the step (1b)). The first mixed-kneaded body does not include CNTs. Because the second mixed-kneaded body has a relatively low solid content, it is possible to reduce the shearing force in the step (1c) applied for dispersing CNTs. As a result, it is possible to reduce the load applied to CNTs during mixing and kneading in the step (1c), making it possible to prevent the CNTs from being cut into short pieces or otherwise becoming shorter. This, in turn, can increase the proportion of CNTs for connecting the active material particles to each other, making it possible to form good conductive paths between the active material particles to enhance cycling performance of the secondary battery. In addition, because the second mixed-kneaded body with a relatively low solid content are mixed and kneaded with CNTs, an active material layer with a high proportion of the first CNTs to all the CNTs can be formed.

The solid content in the step (1a) (the solid content of the first mixed-kneaded body) may be from 61 to 65 weight %, or may be from 62 to 65 weight %, or may be from 63 to 64 weight %. When the solid content in the step (1a) falls within the above-mentioned range, covering of the surface of the active material particles with the first binder is facilitated.

The step (1a) may include a step to dry mix the active material particles and the first binder to obtain a mixture, and a step to mix and knead the mixture and water at a solid content within the range of 60 to 65 weight %. The solid content in the step to mix and knead the mixture and water may be from 61 to 65 weight %, or may be from 62 to 65 weight %, or may be from 63 to 64 weight %.

The solid content in the step (1b) (the solid content of the second mixed-kneaded body) may be 49 weight % or less, or may be 48 weight % or less, or may be from 35 to 50 weight %, or may be from 40 to 49 weight %, or may be from 43 to 48 weight %.

The first step may further include a step to mix and knead the third mixed-kneaded body and a second binder (hereinafter also called “the step (1d)”). In this case, it is preferable that the first binder be at least one of CMC and PAA and the second binder be SBR.

The first step may be carried out by using a stirrer equipped with a stirring blade. Examples of the stirrer include a kneader, a homogenizing disperser, and the like, and one of them may be used alone or they may be used in combination. For example, it is possible that a kneader is used in the step (1a) and the step (1b) and a homogenizing disperser is used in the step (1c) and the step (1d).

The number of revolutions of the stirring blade in each step of the first step is not particularly limited. The number of revolutions of the stirring blade in the step (1a) may be from 10 to 65 rpm, or may be from 20 to 60 rpm, or may be from 30 to 55 rpm. The duration of mixing and kneading in the step (1a) may be from 10 to 200 min, or may be from 70 to 150 min, or may be from 80 to 120 min.

The number of revolutions of the stirring blade in the step (1b) may be from 5 to 50 rpm, or may be from 10 to 40 rpm, or may be from 20 to 35 rpm. The duration of mixing and kneading in the step (1b) may be from 10 to 180 min, or may be from 20 to 150 min, or may be from 25 to 120 min, for example.

The number of revolutions of the stirring blade in the step (1c) may be from 500 to 3000 rpm, or may be from 1000 to 2000 rpm, or may be from 1200 to 1800 rpm. The duration of mixing and kneading in the step (1c) may be from 10 to 180 min, or may be from 20 to 150 min, or may be from 25 to 100 min, for example.

The number of revolutions of the stirring blade in the step (1d) may be from 500 to 4000 rpm, or may be from 1000 to 3000 rpm, or may be from 1500 to 2500 rpm. The duration of mixing and kneading in the step (1d) may be from 0.5 to 100 min, or may be from 1 to 60 min, or may be from 3 to 30 min, for example.

The second step is a step to form the active material layer by using the slurry prepared in the first step. The second step can include a step to apply the slurry to a negative electrode current collector to form a coating layer and dry the coating layer, and it may further include a step to compress the dried coating layer. As the negative electrode current collector, the above-mentioned material may be used.

### (Non-Aqueous Electrolyte Secondary Battery)

A non-aqueous electrolyte secondary battery according to the present embodiment (hereinafter also called “the present battery”) includes the present negative electrode, and, usually, it includes an electrode assembly that includes the present negative electrode, and a non-aqueous electrolyte solution. The present battery may have a battery case for accommodating the electrode assembly and the non-aqueous electrolyte solution. The battery case can include an exterior package having an opening, as well as a sealing plate for sealing the opening. Each of the exterior package and the sealing plate is preferably made of metal, can be formed by using aluminum, aluminum alloy, iron, iron alloy, or the like, and, for example, can be formed by using an aluminum laminated film. Between the electrode assembly and the exterior package, a resin sheet may be provided as an electrode holder.

The electrode assembly may include the present negative electrode, a positive electrode, and a separator. In the electrode assembly, the active material layer of the present negative electrode faces a positive electrode active material layer of the positive electrode, with the separator interposed therebetween. The electrode assembly may be a stack-type one that is formed by stacking the present negative electrode, the positive electrode, and the separator, or may be a wound-type one that is formed by stacking the present negative electrode, the positive electrode, and the separator and winding the resulting stack.

The positive electrode usually has a positive electrode current collector and a positive electrode active material layer, and, for example, the positive electrode current collector is a metal foil that is made by using an aluminum material such as aluminum and aluminum alloy. The positive electrode active material layer includes positive electrode active material particles, and may further include a conductive material, a binder, and the like. Examples of the positive electrode active material particles include particles of a lithium transition metal oxide of layered type, spinel type, or the like (for example, LiNiCoMnO₂, LiNiO₂, LiCoO₂, LiFeO₂, LiMn₂O₄, LiNi_{0.5}Mn_{1.5}O₄, LiCrMnO₄, LiFePO₄, LiNi_{1/3}Co_{1/3}Mn_{1/3}O₂). The lithium transition metal oxide may be lithium-nickel-cobalt-manganese composite oxide (NCM). Examples of the conductive material include carbon materials such as fibrous carbon (CNTs (SWCNTs, DWCNTs)), carbon black (for example, acetylene black, Ketjenblack), coke, activated carbon, and the like. Examples of the binder include polyvinylidene difluoride (PVdF), polytetrafluoroethylene (PTFE), SBR, and the like.

The separator has a base material, and may have a functional layer on at least one side of the base material. The base material can be a porous sheet such as a film and a nonwoven fabric made of a resin such as polyethylene, polypropylene, polyester, cellulose, and/or polyamide. The base material may have a monolayer structure or a multilayer structure. The functional layer may be, for example, either an adhesive layer or a heat-resistant layer, or both. The adhesive layer can be formed with an adhesive agent, for example. The heat-resistant layer can include a filler and a binder, for example.

The non-aqueous electrolyte solution is preferably obtained by adding a supporting salt to a non-aqueous solvent such as an organic solvent. Examples of the supporting salt include LiPF₆, LiBF₄, LiClO₄, LiFSO₃, LiBOB (lithium bis(oxalato)borate), and the like. The non-aqueous electrolyte solution may include one, two, or more supporting salts, among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents, among these.

### (Method of Producing Non-Aqueous Electrolyte Secondary Battery)

The method of producing the present battery includes a step to produce a negative electrode by the method of producing the present negative electrode. The method of producing the present battery may further include a step to obtain an electrode assembly by using the present negative electrode, a positive electrode, and a separator, and a step to place the electrode assembly and a non-aqueous electrolyte solution in a battery case.

### EXAMPLES

In the following, the present disclosure will be described in further detail by way of Examples and Comparative Examples. FIG. 4 to FIG. 7 are scanning transmission electron microscope images (SEM images) of the surface of the active material layer of the negative electrode obtained in Examples 1 and 2 as well as Comparative Examples 1 and 2, respectively.

### Example 1

### (Production of Negative Electrode (1))

Graphite particles were used as carbon-based particles, and particles of a Si—C composite (SiC composite particles) were used as metal-based particles. The average particle size, D50, of the graphite particles was 17 μm, and the specific surface area (BET) of the graphite particles was 2.2 m²/g. CNTs had the G/D ratio as specified in Table 1. A slurry (1) was prepared by the procedure described below, with the use of a kneader (manufactured by PRIMIX Corporation, HIVIS MIX 2P-1) and a homogenizing disperser (manufactured by PRIMIX Corporation, ROBOMIX), as a stirrer.

Firstly, the carbon-based particles, the metal-based particles, and CMC and PAA as first binders were dry mixed to obtain a mixture. Then, water was added to the resulting mixture to achieve a solid content of 65 weight %, and mixing and kneading were performed for 90 min at a number of revolutions of the kneader of 50 rpm to obtain a first mixed-kneaded body (a step (1a)). Water was further added to the resulting first mixed-kneaded body to achieve a solid content of 48%, and mixing and kneading were performed for 30 min at a number of revolutions of the kneader of 30 rpm to obtain a second mixed-kneaded body (a step (1b)). CNTs (water-soluble paste with a solid content of 1 weight %) were added to the resulting second mixed-kneaded body, and mixing and kneading were performed for 30 min at a number of revolutions of the homogenizing disperser of 1500 rpm to obtain a third mixed-kneaded body (a step (1c)). SBR was added to the resulting third mixed-kneaded body, and mixing and kneading were performed for 30 min at a number of revolutions of the homogenizing disperser of 1500 rpm to obtain a slurry (1) (a step (1d)). The blending ratio for the slurry (1) was (graphite particles):(SiC composite particles):CNT:CMC:PAA:SBR=91:9:0.05:1:1:1 (weight ratio).

The slurry (1) obtained in the above-mentioned manner was applied to both sides of a copper foil having a thickness of 8 μm serving as a negative electrode current collector, and dried and compressed to obtain a negative electrode (1). The mass of the active material layer of the negative electrode (1) per unit area (the total mass per unit area for both sides) was 195 g/m², the thickness of the active material layer (per one side) was 130 μm, and the packing density of the active material layer was 1.52 g/cc. An SEM image of the surface of the active material layer of the negative electrode (1) is given in FIG. 4. The active material layer of the negative electrode (1) included CMC and PAA (a first binder) that covered at least part of the surface of the active material particles and that did not include CNTs, and it also included CNTs (first CNTs) lying over the surface of CMC and PAA as well as CNTs (second CNTs) connecting a pair of the active material particles to each other.

### (Production of Positive Electrode)

Lithium-nickel-cobalt-manganese composite oxide (NCM) as positive electrode active material particles, acetylene black (AB) as a conductive material, and polyvinylidene difluoride (PVdF) as a binder were used in a weight ratio of (positive electrode active material particles):AB:PVdF=100:1:1, and they were mixed with N-methylpyrrolidone (NMP) as a solvent to obtain a positive electrode composite material slurry. The resulting positive electrode composite material slurry was applied to an aluminum foil having a thickness of 15 μm serving as a positive electrode current collector, and dried and compressed to obtain a positive electrode.

### (Production of Non-Aqueous Electrolyte Secondary Battery)

A lead was attached to each of the negative electrode and the positive electrode obtained in the above-mentioned manner, and the negative electrode and the positive electrode were stacked on top of one another with a separator interposed therebetween, to obtain an electrode assembly. The resulting electrode assembly was inserted into an exterior package made of an aluminum-laminated sheet, and a non-aqueous electrolyte solution was injected, followed by sealing the opening of the exterior package to obtain a test cell (a laminated cell) (1). The non-aqueous electrolyte solution was a mixed solvent that contained ethylene carbonate (EC), ethyl methyl carbonate (EMC), and dimethyl carbonate (DMC) in a volume ratio of EC:EMC:DMC=20:40:40, in which LiPF₆ as a lithium salt was dissolved in a concentration of 1 mol/L.

### Example 2

### (Production of Negative Electrode (2))

A negative electrode (2) was produced by the same procedure as in Example 1 except that CNTs having the G/D ratio as specified in Table 1 were used. An SEM image of the surface of the active material layer of the negative electrode (2) is given in FIG. 5. The active material layer of the negative electrode (2) included CMC and PAA (a first binder) that covered at least part of the surface of the active material particles and that did not include CNTs, and it also included CNTs (first CNTs) lying over the surface of CMC and PAA as well as CNTs (second CNTs) connecting a pair of the active material particles to each other.

### (Production of Non-Aqueous Electrolyte Secondary Battery)

A test cell (2) was obtained by the same procedure as in Example 1 except that the negative electrode (2) was used instead of the negative electrode (1).

### Comparative Example 1

(Production of Negative Electrode (c1))

The carbon-based particles and the metal-based particles used in Example 1, together with CMC and PAA as first binders, were dry mixed to obtain a mixture. Then, CNTs having the G/D ratio as specified in Table 1 (water-soluble paste with a solid content of 1 weight %) and water were added to the resulting mixture to achieve a solid content of 64 weight %, and mixing and kneading were performed for 90 min at a number of revolutions of the kneader of 50 rpm. Subsequently, water was further added and mixing and kneading were performed for 30 min at a number of revolutions of the kneader of 30 rpm, followed by adding SBR as a second binder and mixing and kneading for 5 min at a number of revolutions of the kneader of 30 rpm to obtain a slurry (c1) with a solid content of 46 weight %. The blending ratio for the slurry (c1) was (graphite particles):(SiC composite particles):CNT:CMC:PAA:SBR=91:9:0.05:1:1:1 (weight ratio).

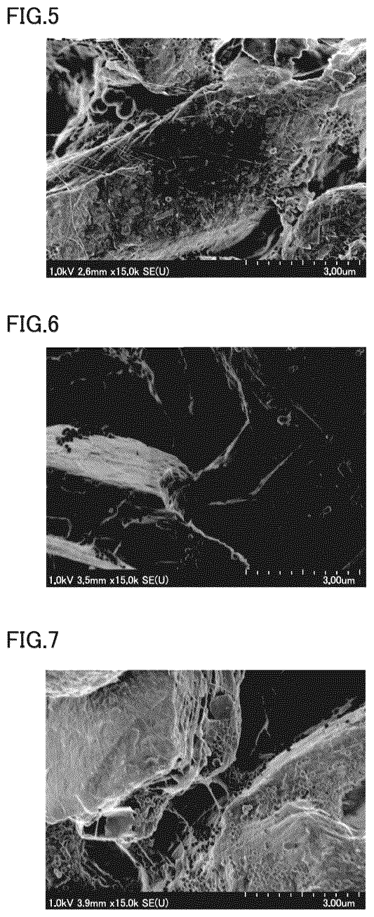

A negative electrode (c1) was obtained by the same procedure as in Example 1 except that the slurry (c1) was used instead of the slurry (1). An SEM image of the surface of the active material layer of the negative electrode (c1) is given in FIG. 6. In the active material layer of the negative electrode (c1), a mixed body in which CNTs and the binder (CMC and PAA) were mixed covered the surface of the active material particles and connected a pair of the active material particles to each other.

### (Production of Non-Aqueous Electrolyte Secondary Battery)

A test cell (c1) was obtained by the same procedure as in Example 1 except that the negative electrode (c1) was used instead of the negative electrode (1).

### Comparative Example 2

(Production of Negative Electrode (c2))

A negative electrode (c2) was produced by the same procedure as in Comparative Example 1 except that CNTs having the G/D ratio as specified in Table 1 were used. An SEM image of the surface of the active material layer of the negative electrode (c2) is given in FIG. 7. In the active material layer of the negative electrode (c2), a mixed body in which CNTs and the binder (CMC and PAA) were mixed covered the surface of the active material particles and connected a pair of the active material particles to each other.

### (Production of Non-Aqueous Electrolyte Secondary Battery)

A test cell (c2) was obtained by the same procedure as in Example 1 except that the negative electrode (c2) was used instead of the negative electrode (1).

[Determination of G/D ratio of CNTs]

A CNT dispersion was placed on a cover glass, and to a region thereof having a diameter of 300 μm, laser light having an excitation wavelength of 532 nm was applied with the use of a Raman microscope (manufactured by HORIBA) to obtain a Raman spectrum. In the Raman spectrum thus obtained, the G/D ratio was calculated, with G defined as the intensity of the highest peak within the range of 1550 to 1650 cm⁻¹ and D defined as the intensity of the highest peak within the range of 1300 to 1400 cm⁻¹. Results are given in Table 1.

### [Determination of Average Length of CNTs and CNT Proportion]

### (Obtaining SEM Image)

With the use of a scanning transmission electron microscope (SEM, manufactured by Hitachi High-Tech), at an accelerating voltage of 1 kV, the surface of the active material layer of the negative electrode was examined in an SEM image having a field of view of 9×7 μm.

### (Determination of Average Length of CNTs)

Imaging software was used to mark CNTs in the SEM image in the form of lines to measure the perimeter of each line, and half the value was regarded as the length of the CNT. Because a CNT has a very long length as compared to the diameter in terms of the aspect ratio, contribution of the width of the line to the perimeter is negligible. For all the CNTs in the SEM image, the lengths of the CNTs were determined, and the average value of them was regarded as the average length of the CNTs. Results are given in Table 1.

### (Determination of CNT Proportion)

The proportion [%] of CNTs not mixed with CMC and PAA (the first binder) to all the CNTs in the SEM image obtained in the above-mentioned manner (the CNT proportion [%]) was calculated by the below equation. Results are given in Table 1.

CNT proportion [%]=((Area of CNTs in SEM image not mixed with first binder)/(Area of all CNTs in SEM image))×100

### [Evaluation of Cycling Performance (1)]

In an environment at 25° C., the test cell was charged and discharged for N cycles, where one cycle consisted of charging by constant-current·constant-voltage charging (CCCV) at a value of current of 0.2 C to reach 4.2 V (cut at 0.1 C) and then discharging at a value of current of 0.33 C to reach 2.5 V (CC discharging). For the test cells obtained in Example 1 and Comparative Example 1, the number of charge-discharge repetition, N, was 100 cycles, and for the test cells obtained in Example 2 and Comparative Example 2, the number of charge-discharge repetition, N, was 150 cycles. By the following equation, the discharged capacity at the Nth cycle relative to the discharged capacity at the first cycle was calculated, which was regarded as capacity retention [%]. Results are given in Table 1.

$$Capacity retention [ \% ] = ( ( Discharged capacity at the Nth cycle ) \text{} / ( Discharged capacity at the first cycle ) ) \times 100$$

TABLE 1

| | Ex. 1 | Ex. 2 | Comp. Ex. 1 | Comp. Ex. 2 |
|---|---|---|---|---|
| Negative electrode | (1) | (2) | (c1) | (c2) |
| Slurry | (1) | (2) | (c1) | (c2) |
| CNTs | | | | |
| G/D ratio | 11.81 | 69.19 | 11.81 | 69.19 |
| Average length [μm] | 2.11 | 1.98 | 1.64 | 1.57 |
| CNT Proportion*¹ [%] | 93.9 | 87.6 | 11.3 | 52.0 |
| Test cell | (1) | (2) | (c1) | (c2) |
| Capacity retention [%] | 72.5 | 96.46 | 71.4 | 96.25 |

*¹Proportion of CNTs not mixed with the first binder in the SEM image

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A negative electrode for a non-aqueous electrolyte secondary battery, comprising:
an active material layer including active material particles, carbon nanotubes, and a first binder, wherein
the active material particles include metal-based active material particles and carbon-based active material particles,
an average length of the carbon nanotubes determined by analysis of a scanning transmission electron microscope image of the active material layer is 1.5 μm or more,
at least part of the first binder is not mixed with the carbon nanotubes and covers at least part of a surface of the active material particle, and
the carbon nanotubes include first carbon nanotubes adhered to and lying over the first binder that is not mixed with the carbon nanotubes and covers a surface of the active material particle, and second carbon nanotubes each connecting a pair of the active material particles to each other.

2. The negative electrode according to claim 1, wherein a proportion of the carbon nanotubes that are not mixed with the first binder to all the carbon nanotubes present in the active material layer determined by analysis of the scanning transmission electron microscope image of the active material layer is more than 60%.

3. The negative electrode according to claim 1, wherein the metal-based active material particles include particles of one or more types selected from the group consisting of Si, SiOx, and a Si—C composite.

4. The negative electrode according to claim 1, wherein the metal-based active material particles include particles of a Si—C composite.

5. The negative electrode according to claim 1, wherein the carbon nanotubes are single-walled carbon nanotubes.

6. The negative electrode according to claim 1, wherein a G/D ratio of the carbon nanotubes is 80 or less.

7. The negative electrode according to claim 1, wherein the first binder is at least one of carboxymethylcellulose and polyacrylic acid.

8. The negative electrode according to claim 7, wherein
the active material layer includes a second binder, the second binder is different from the first binder, and
the second binder includes styrene-butadiene rubber.

9. A non-aqueous electrolyte secondary battery comprising the negative electrode according to claim 1.

10. A method of producing a negative electrode for a non-aqueous electrolyte secondary battery, the method comprising:
a first step to prepare a slurry; and
a second step to form an active material layer of the negative electrode by using the slurry, wherein
the slurry includes active material particles, a first binder, carbon nanotubes, and water,
the active material particles include metal-based active material particles and carbon-based active material particles, and
the first step includes
a step (1a) to obtain a first mixed-kneaded body by mixing and kneading the active material particles, the first binder, and water at a solid content within a range of 60 to 65 weight %,
a step (1b) to obtain a second mixed-kneaded body by adding water to the first mixed-kneaded body and mixing and kneading at a solid content within the range of 50 weight % or less, and
a step (1c) to obtain a third mixed-kneaded body by mixing and kneading the second mixed-kneaded body and the carbon nanotubes.

11. The method of producing a negative electrode according to claim 10, wherein
the first binder is at least one of carboxymethylcellulose and polyacrylic acid,
the first step further includes a step to mix and knead the third mixed-kneaded body and a second binder, and
the second binder includes styrene-butadiene rubber.

12. The method of producing a negative electrode according to claim 10, wherein the step (1a) includes:
a step to dry mix the active material particles and the first binder to obtain a mixture; and
a step to mix and knead the mixture and water at a solid content within a range of 60 to 65 weight %.

13. The method of producing a negative electrode according to claim 10, wherein the metal-based active material particles include particles of one or more types selected from the group consisting of Si, SiOx, and a Si—C composite.

14. The method of producing a negative electrode according to claim 10, wherein the first binder is at least one of carboxymethylcellulose and polyacrylic acid.

15. The method of producing a negative electrode according to claim 10, wherein a G/D ratio of the carbon nanotubes is 80 or less.

16. A method of producing a non-aqueous electrolyte secondary battery, the method comprising a step to produce a negative electrode by the method of producing a negative electrode according to claim 10.
